(19) United States
(12) Patent Application Publication
(10) Pub. No.: US 2022/0134141 A1
(43) Pub. Date: May 5, 2022

(54) SEALABLE FACE MASK

(71) Applicant: Humantec Inc., Barrie (CA)

(72) Inventors: Steven A. Copeland, Barrie (CA); Nicholas Teixeira, Angus (CA)

(73) Assignee: Humantec Inc., Barrie (CA)

(21) Appl. No.: 17/090,299

(22) Filed: Nov. 5, 2020

(51) Int. Cl. A62B 18/02; A62B 23/02; A62B 18/08

(52) U.S. Cl. CPC A62B 18/025; A62B 18/084; A62B 23/025

(57) ABSTRACT

A face mask and method of use are disclosed. A base of the face mask is placed around a lower region of the person's nose. A horizontal wall of the base is positioned under the person's nose and first and second bosses extending upwardly from the wall are positioned in the user's nostrils. Holes in the bosses allow the user to breathe through their nose. A filter assembly extends downwardly from the base and fits over the person's mouth and under their chin. An elastic frame on the filter assembly is press-sealed to the user's skin on either side of their mouth and under their chin. The horizontal wall prevents airflow between the environment and a space in front of the user's mouth. Exhaled and inhaled air is forced to pass through the filter assembly's filter, trapping infectious respiratory moisture droplets in the filter.

### TECHNICAL FIELD

This disclosure is directed to personal protective equipment (PPE). In particular, this disclosure is directed to face masks. Specifically, the disclosure relates to a face mask that extends only over the nose, mouth, and chin of a person wearing the face mask and is sealable to the person's face. The face mask includes a base that is received around a lower region of the person's nose and is sealed thereto. The face mask further includes a filter assembly extending downwardly from the base that is sealed to the person's skin on either side of their mouth and below their chin.

### BACKGROUND

### Background Information

Face masks are PPE devices that are used for two purposes. Firstly, a face mask ensures that any moisture droplets being breathed out or expelled from a person's body during talking, coughing, and/or sneezing are captured by the fabric of the mask. The mask therefore substantially prevents those moisture droplets from entering into the environment surrounding the person. Secondly, a face mask acts as a shield that aids in preventing moisture droplets expelled or breathed out by another person from being breathed in. In these two ways, face masks help to reduce the incidence of disease. Face masks have become particularly important in the fight against COVID-19.

Most currently known face masks are provided with a metal strip that extends along at least a part of the top region of the mask. The metal strip is deformed to assume the general shape of a person's nose by pinching the metal strip against the nose. However, due to the wide variety of nose and face shapes, the provision of this metal strip can result in the presence of gaps between the mask fabric and the person's skin. These gaps tend to reduce the protection offered by the face mask. Additionally, if the person wears eyeglasses, these gaps tend to direct moist air upwardly toward the eyeglasses and cause the glasses to steam up.

Additionally, most currently known face masks utilize straps or ties that extend outwardly from the face mask and pass around the back of the person's head, neck, or around their ears. This arrangement requires that a large portion of the person's face be covered by the mask. Additionally, the straps or ties can be uncomfortable to wear, tend to interfere with the person's hair, and can result in discomfort or abrasions behind the ears.

A number of different face masks have been proposed in the prior art. Brunner (U.S. Pat. No. 2,281,744) discloses a face mask that covers a person's nose, mouth, and cheeks. A long cord extends along the left and right side edges of the mask and along the bottom edge thereof. A length of the cord is pulled outwardly from each of the left and right side edges of the mask and is passed around the person's left or right ear. The ends of the cord extend out of the bottom edge of the mask below the chin. The person can adjust the fit of the mask by pulling downwardly on the cord ends to tighten the mask against the cheeks and around the ears. The mask has obvious drawbacks from the point of view that there will be gaps between the mask fabric and the person's cheeks, particularly on either side of the nose. Additionally, the ends of the cord will dangle down from the user's chin and will move into their vision each time they bend their head forward.

Hower (U.S. Pat. No. 2,457,044) discloses a breath diverter face mask that only covers the user's nose and has straps that pass around the forehead and around the back of the head. The face mask does not trap any moisture droplets breathed out through the user's nose but simply redirects them upwardly to exit the mask proximate the user's forehead.

Conrad et al (U.S. Pat. No. 3,828,366) discloses a transparent mask that covers substantially the entire face of the user, including their eyes and forehead. The mask is fabricated from a thin, plastic material except for a porous strip of fabric which will be positioned in front of the person's nose and mouth when the mask is worn. A flexible, U-shaped band is provided in an upper region of the mask and is used to secure the mask to the person's head. The band crosses the person's forehead and extends along the sides of their head, proximate their temples. An elastic cord passes from one side of the band, through the left side of the mask, along the bottom edge thereof, and up along the right side of the mask, terminating in the other side of the band. The elastic cord helps the mask to conform closely to the shape of the user's face and thereby remain in place. While this mask might be useful in a healthcare setting instead of or in addition to a face shield, it is not particularly practical for everyday use when a person is working or shopping, for example.

Huber et al (U.S. Pat. No. 4,454,881) discloses a multi-layer face mask that is made from a material that will generally conform to a person's face. A molded resilient bead extends around the perimeter of the mask to form an edge seal between the mask and the person's face, particularly along the sides of the nose and the upper cheekbones. A strap is provided that extends from the sides of the mask to pass around the back of the wearer's head.

Griesback, III et al (U.S. Pat. No. 6,948,499) discloses a cup-like face mask that is rigid enough that the mask may be gripped in one hand and applied to the face. The peripheral edge of the mask is configured to be able to conform to contours of the user's face and includes an adhesive that helps the mask stay seated on the person's face. A malleable member is provided proximate an upper edge of the mask and is able to be molded to help the mask conform to the user's nose and upper cheeks.

Reaux (U.S. 2009/0126064) discloses a mask and shield assembly that is reversible. The mask includes an attachment device and a frame member is able to detachably engage the attachment device and be used to secure the mask on a persons' face. The attachment device is essentially one or more holes made in the fabric of the mask. The frame member is threaded through one or more of the holes and then extends outwardly therefrom to contact the user's head in some manner. The frame member may be provided in any one of a number of different configurations, some of which extend from the mask to over the top of the user's ears, and others which pass around the back of the user's neck.

In substantially all of the prior art devices referenced above, the mask itself covers the user's nose, mouth, chin, and cheeks.

### SUMMARY

The face mask of the present disclosure is configured to only pass over the user's nose and mouth and under the user's chin. The mask does not extend across the user's cheeks to any great extent but is, instead sealed to the person's nose by a base of the face mask and is sealed to the skin on the person's face on either side of their mouth and under their chin. This configuration of the face mask helps to ensure that all air breathed in or breathed out by the person passes through the filter of the filter assembly. Furthermore, the configuration of the face mask helps to ensure that little to no air, and therefore little to no exhaled respiratory moisture droplets escape through gaps between the face mask and the person's skin, particularly from gaps on either side of the nose. The face mask in accordance with the present disclosure may therefore more effectively help reduce the spread of infectious disease by restricting the quantity of infectious respiratory moisture droplets that are able to escape moving through the face mask's filter.

In one aspect, an exemplary embodiment of the present disclosure may provide a face mask comprising a base; a filter assembly operatively engaged with the base; wherein the base is adapted to be received about a region of the person's nose when the face mask is worn and seal the face mask to the person's nose. In one embodiment the filter assembly extends downwardly from the base and is adapted to receive the person's chin therein and seal the face mask to the person's face adjacent their mouth. In one embodiment, a filter is provided in the filter assembly; said filter being configured to permit air to flow therethrough and being further configured to substantially reduce or prevent moisture droplets from flowing therethrough.

In one embodiment, the base may be fabricated from a resilient or flexible material and is generally U-shaped when viewed from above. In one embodiment, the base may be configured to approximate a width of a lower region of the person's nose when the face mask is worn. In one embodiment, the base may include a first wall oriented generally vertically when the face mask is worn; and a second wall oriented generally horizontally relative to an interior surface of the first wall; and wherein the second wall is adapted to extend under the person's nose and to seal the face mask to the person's nose. In one embodiment, the second wall may include a first boss and a second boss that extend upwardly from an upper surface of the second wall, wherein the first boss and second boss are laterally spaced a distance apart from one another; and an aperture is defined in each of the first boss and the second boss, and wherein the first boss and second boss are adapted to be at least partially received into the person's nostrils when the face mask is worn. In one embodiment, each of the first boss and the second boss may be generally hemispherical in shape and fabricated from a flexible material. In one embodiment, a remaining portion of the second wall extending outwardly from the first boss and the second boss may form a skirt that is adapted to contact the person's upper lip; wherein the skirt substantially reduces or prevents expelled air from flowing upwardly from the person's nose and mouth and out of the face mask adjacent the person's nose; and further substantially reduces or prevents air from an environment surrounding the person from flowing inwardly adjacent the person's nose and into a space defined between the face mask and the person's face.

In one embodiment, the filter assembly may further comprise a frame and the filter may be mounted to the frame. In one embodiment, the frame may configure the filter to assume a cupped-shape that is adapted to receive the person's chin therein when the face mask is worn. In one embodiment, the frame may be fabricated from an elastic material and may be adapted to the filter assembly to the person's skin when the face mask is worn. In one embodiment, the face mask may further comprise a support assembly operatively engaged with the base, wherein the support assembly extends upwardly from the base and may be adapted to engage the person's nose when the face mask is worn. In one embodiment, the support assembly may comprise a bendable frame; and a pair of nose pads mounted on the bendable frame, said nose pads being adapted to rest on a first side and a second side of the person's nose when the face mask is worn. In one embodiment, the face mask may further comprise a mounting assembly interposed between the base and the filter assembly, wherein the mounting assembly is detachably engaged with the base. In one embodiment, the mounting assembly may be permanently secured to the filter assembly. In one embodiment, the face mask may further comprise a neck strap that is detachably engagable with the filter assembly, wherein the neck strap is adapted to pass around a back of the person's neck when the face mask is worn.

In another aspect, and exemplary embodiment of the present disclosure may provide a face mask kit that comprises a base and several filter assemblies that are selectively operatively engaged with the base, where the base and filter assemblies are as described above. The several filter assemblies may be substantially identical to one another. In other embodiments, the several filter assemblies may have fabric filters that are differently patterned and/or differently colored.

In another aspect, an exemplary embodiment of the present disclosure may provide a method of preventing a spread of infection caused by infectious respiratory moisture droplets, said method comprising providing a face mask for a person to wear on their face while in an environment; engaging a base of the face mask around a lower region of the person's nose; sealing the face mask to the person's nose with the base; and extending a filter assembly downwardly from the base. In one embodiment, the method may further comprise positioning a generally horizontal wall of the base under a bottom end of the person's nose; moving a first boss on the wall into a first nostril of the nose; and moving a second boss on the wall into a second nostril of the nose. In one embodiment, the method may further comprise cupping the person's chin with a filter assembly extending downwardly from the base; sealing the filter assembly to the person's skin alongside the sides of the persons' mouth and under their chin; exhaling and inhaling through a filter provided on the filter assembly; and capturing infectious respiratory moisture droplets in the filter of the filter assembly.

In one embodiment, the method may further comprise sealing the base to the person's upper lip with a skirt of the wall that radiates outwardly from the first boss and the second boss. In one embodiment, the method may further comprise preventing airflow to and from the nose or mouth along the sides of the person's nose with the generally horizontal wall of the base. In one embodiment, the method may further comprise interposing a mounting assembly between the base and the filter assembly; detachably engaging the mounting assembly to the base; removing the mounting assembly and filter assembly from the base periodically; cleaning or replacing the filter assembly on the mounting assembly; and re-engaging the mounting assembly with the cleaned or replaced filter assembly with the base. In one embodiment, the method may further comprise providing a support assembly extending upwardly from the base; resting a pair of nose pads of the support assembly on opposing sides of the person's nose; and when needed, bending a frame of the support assembly to conform to the shape of a bridge of the person's nose. In one embodiment, the method may further comprise engaging a connector assembly of a neck strap with the filter assembly such that a first portion of the neck strap extends outwardly from the connector assembly in a first direction and a second portion of the neck strap extends outwardly from the connector assembly in a second direction; passing the first portion of the neck strap around the back of the person's neck; and securing a free end of the second portion of the neck strap and a free end of the first portion of the neck strap together.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is front elevation view showing a face mask in accordance with the present disclosure being worn by a user;

FIG. 2 is a left side elevation view of the face mask of FIG. 1 being worn by the user;

FIG. 3 is a left side elevation view showing a vertical cross-section through the face mask that is being worn by the user;

FIG. 3A is an enlarged vertical cross-section of the face mask only looking in the direction of line 3A-3A of FIG. 1;

FIG. 4 is an enlarged front, top, left side perspective view of the face mask in accordance with the present disclosure;

FIG. 4A is an enlarged front, top, left side perspective view of the face mask of FIG. 4 shown without the neck strap engaged therewith;

FIG. 5 is an exploded front, top, left side perspective view of the face mask of FIG. 4;

FIG. 6 is a rear elevation view of the face mask with the neck strap removed for clarity and showing a partial cross-section through the base, the mounting assembly and the filter assembly;

FIG. 7 is a rear elevation view of the face mask of FIG. 4 shown on its own and without the neck strap engaged therewith.

Similar numbers refer to similar parts throughout the drawings.

### DETAILED DESCRIPTION

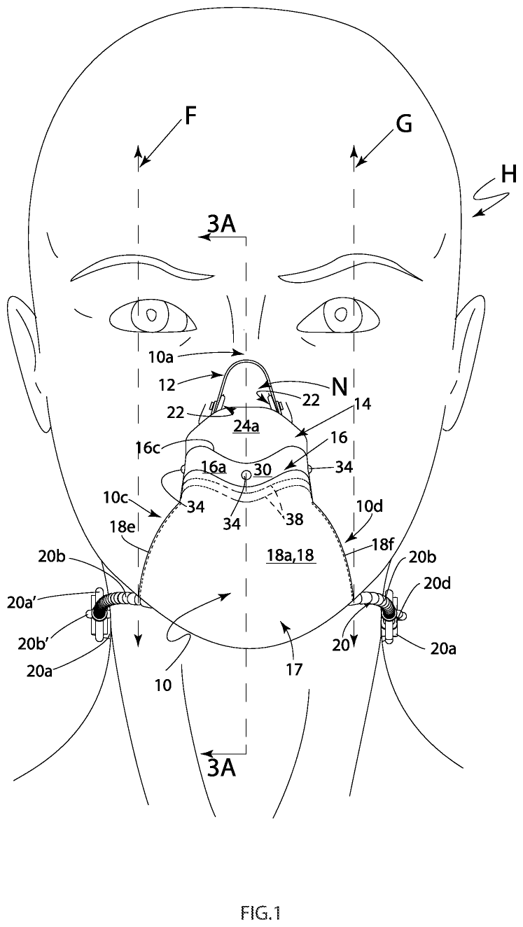

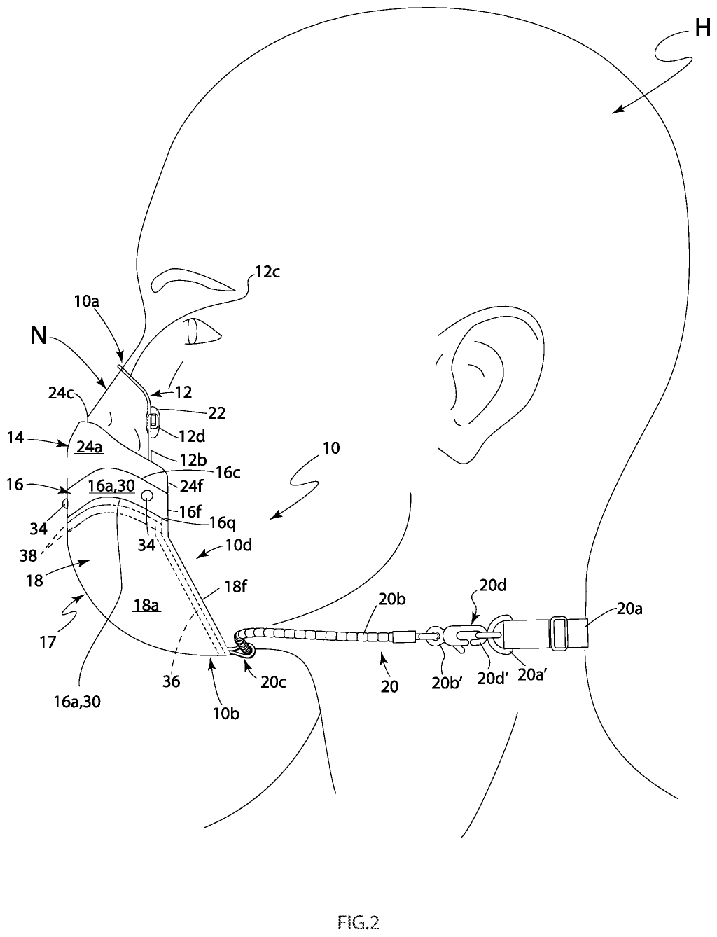

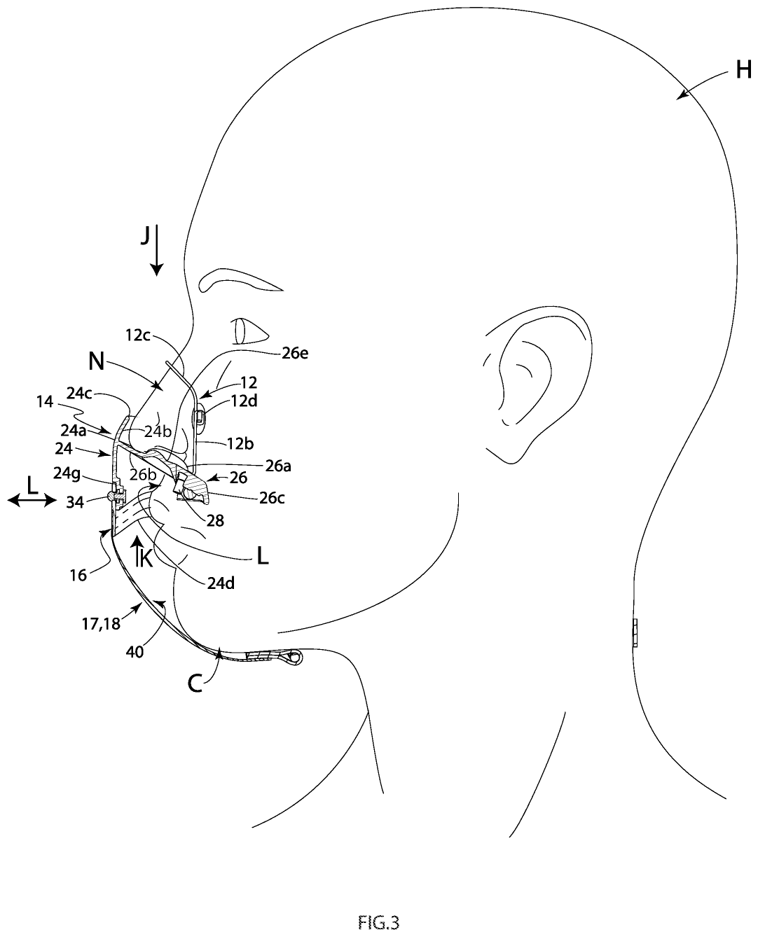

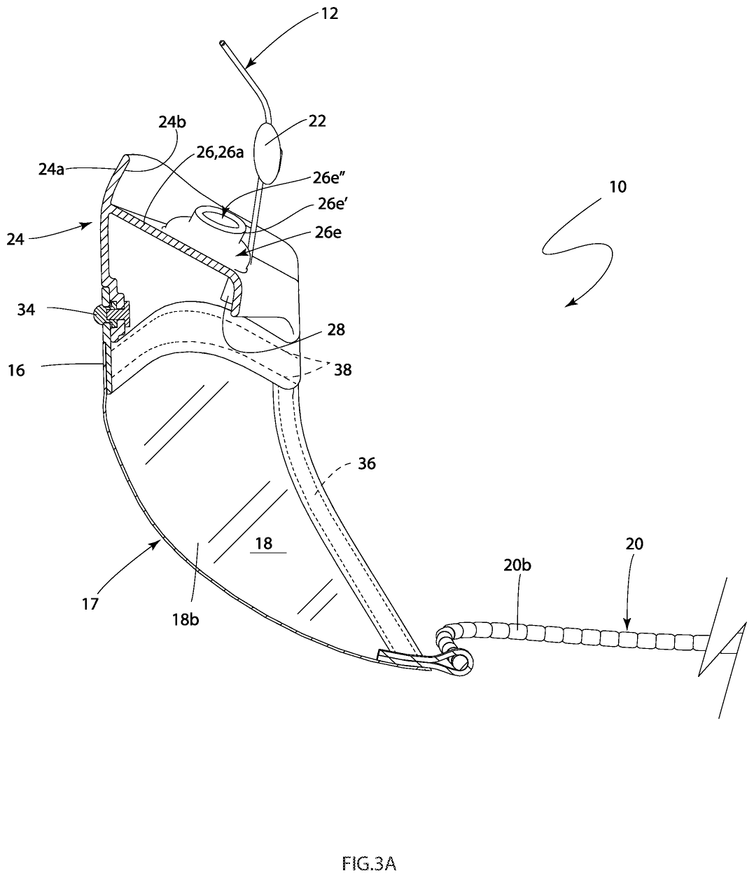

Referring to FIGS. 1-7, there is shown a face mask in accordance with an aspect of the present disclosure, generally indicated at 10. Face mask 10 is configured to be worn on a person's head “H” such that the person's nose “N” and chin “C” (FIG. 3) are covered. FIGS. 1 and 2 show that the face mask 10 has an upper end 10a that extends across the person's nose “N”, a lower end 10b that extends under the person's chin “C”, and side edges 10c, 10d that tend to not extend to any great degree over the person's cheeks or the sides of the person's face. In particular, the side edges 10c, 10d of face mask 10 tend to be located inwardly of the outer corners of the person's eyes “E” and on the skin on either side of the person's mouth. FIG. 1 shows two imaginary vertical lines “F” and “G” that generally signify skin that lays on adjacent the outermost corners of the user's mouth. As is evidenced by the maximum width “W” of face mask 10 being located inwardly of these imaginary lines ‘F’ and ‘G’ it will be understood that face mask 10 does not extend to any great degree along the user's cheeks and towards their ears.

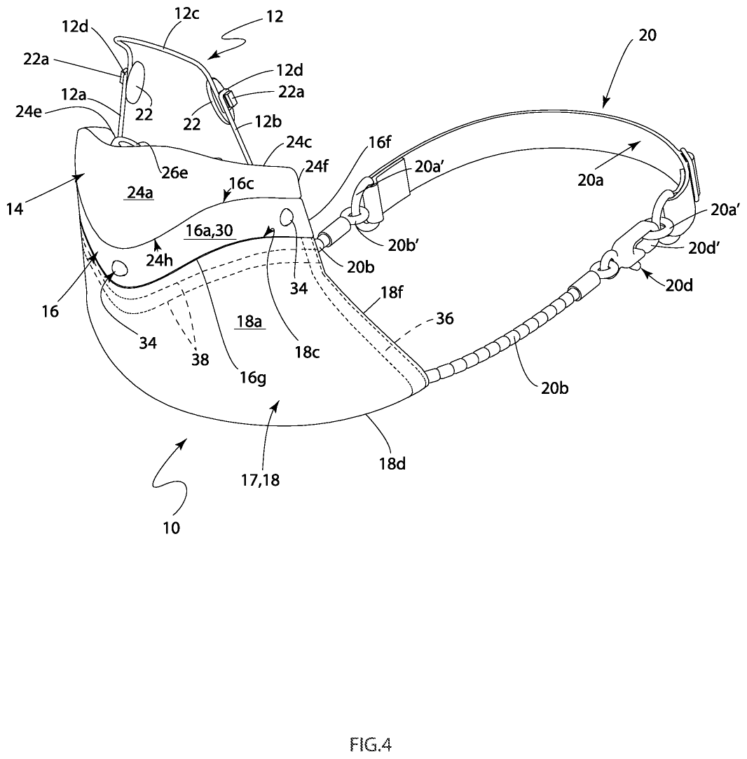

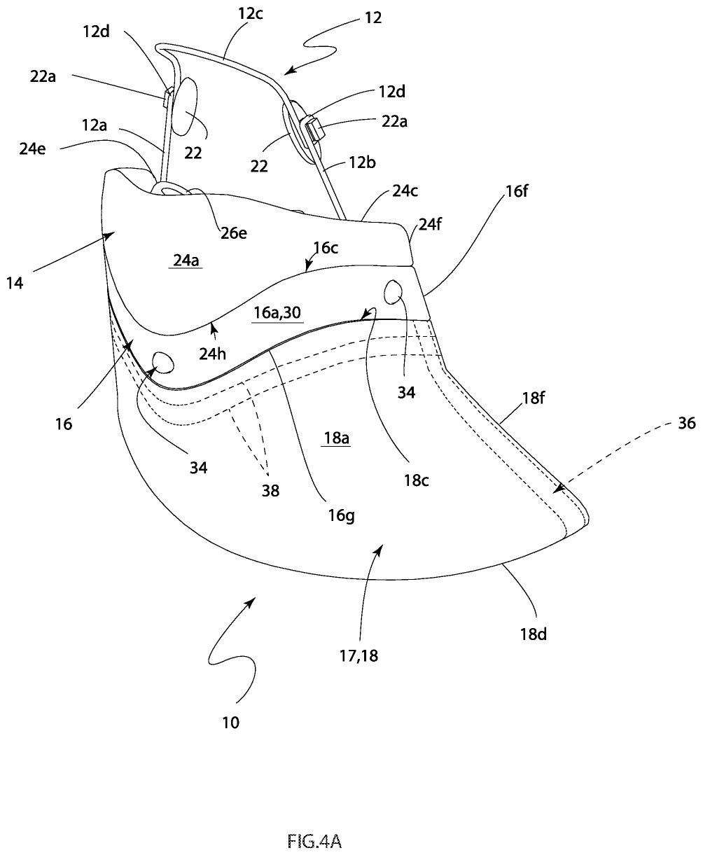

Face mask 10 includes a support assembly 12, a base 14, a mounting assembly 16, and a filter assembly 17. Face mask 10 is illustrated in FIG. 1 as including a neck strap 20 that extends from the filter assembly 17 and around the back of the person's neck. The neck strap 20 may help to secure the face mask 10 on the person's head. In other embodiments, such as illustrated in FIG. 4A, the neck strap 20 is omitted. It should be understood that the neck strap 20 is optional and that the face mask 10 is capable of being sealed to the person's face to a sufficient degree that the mask will remain in place and perform the function of enabling the person to breathe and talk while simultaneously filtering moisture droplets expelled by the person.

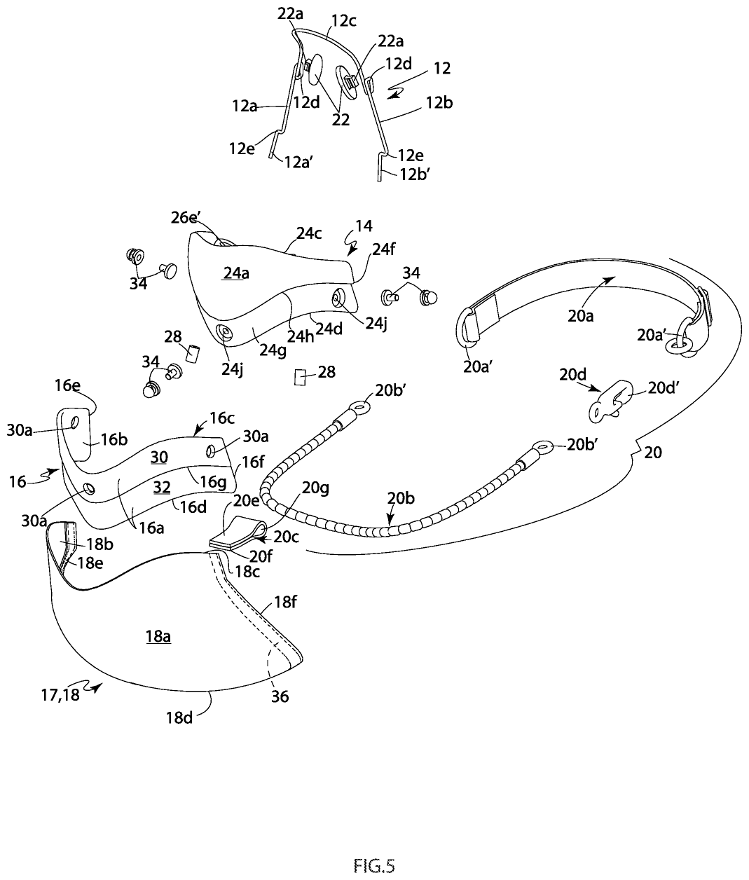

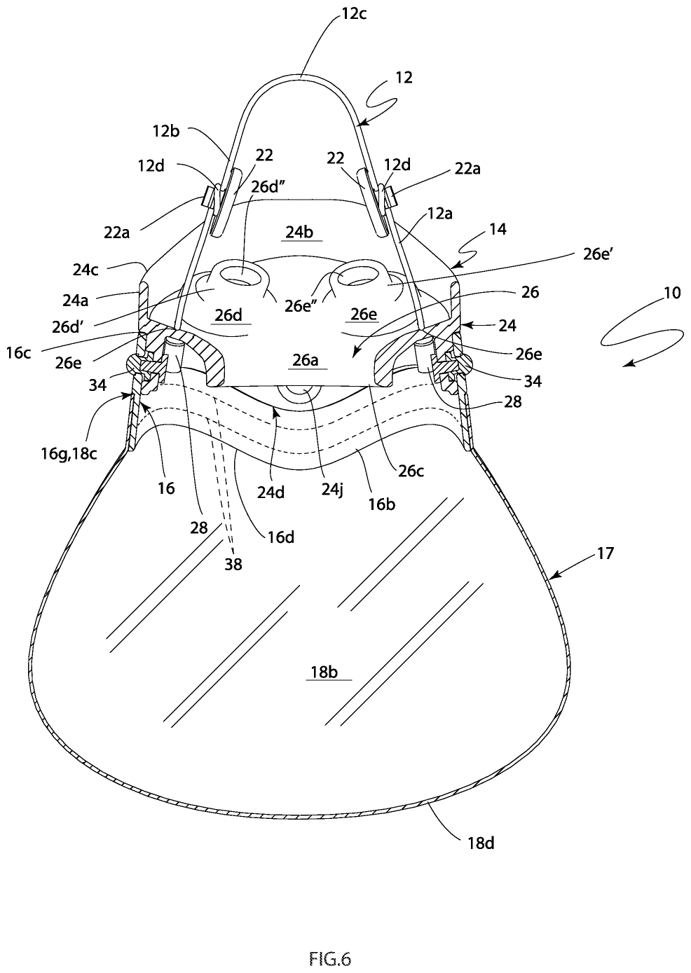

Support assembly 12 is fabricated from a suitable bendable material. One suitable material for fabricating support assembly 12 is a metal wire. When the face mask 10 is worn, the person may effectively mold the wire of support assembly 12 to more closely conform to the shape of their own nose “N”. Support assembly 12 is generally U-shaped in configuration and includes a first leg 12a, a second leg 12b, and a third leg 12c that extends between the first and second legs 12a, 12b. A single piece of wire preferably is bent to form the wire shape illustrated in FIG. 5. Third leg 12c is oriented at an angle of about 45° relative to the upper ends of each of the first leg 12a and second leg 12b. This can be seen in FIG. 2. A loop 12d is formed in each of the first leg 12a and second leg 12b is short distance downwardly from where third leg 12c connects to each of the first and second legs 12a, 12b, respectively. Loop 12d is configured so as to permit engagement of one of two silicone nose pads 22 to the respective legs 12a, 12b. Nose pads 22 are substantially identical to nose pads that would typically be provided on a pair of eyeglasses. A connector 22a from the nose pad 22 will be press-fitted through an aperture defined by each loop 12d of wire as is shown in FIG. 6.

As best seen in FIG. 5, a bend 12e is formed in each of the first leg 12a and second leg 12b a short distance upwardly from the free ends of the legs 12a, 12b. The bends 12e offset a short length of the associated first leg 12a, 12b from the rest of the leg. The offset length of first leg 12a is designated by the reference character 12a′ in FIG. 5. Similarly, the offset length of second leg 12b is designated by the reference character 12b′ in the same figure. The lengths 12a′ and 12b′ form connector members for engagement of support assembly 12 to base 14.

Base 14 is fabricated from a resilient or flexible material. Suitable materials for the fabrication of base 14 are flexible plastics, silicone, or thermoplastic rubber (TPR). Base 14 is a molded to be convex in shape. In particular, base 14 is generally U-shaped when viewed from above. Furthermore, base 14 is shaped and sized to approximate a width of a lower region of the person's nose when face mask 10 is worn. Because base 14 is fabricated from flexible or resilient material, base 14 will stretch somewhat to accommodate different size noses. As illustrated in FIG. 1, base 14 does not extend much beyond the middle of the person's eyes. This feature is unlike PRIOR ART face masks where the upper region of the face mask extends for a distance along the person's cheeks and toward their ears. When placing the face mask 10 on their head, the person is able to move the base 14 upwardly or downwardly along their nose “N” until a comfortable engagement of the base 14 about the nose is achieved. In some instances, the base 14 may be located closer to the person's eyes than is illustrated in FIG. 1, and in other instances, the base 14 may be located further away from the person's eyes than is illustrated in FIG. 1.

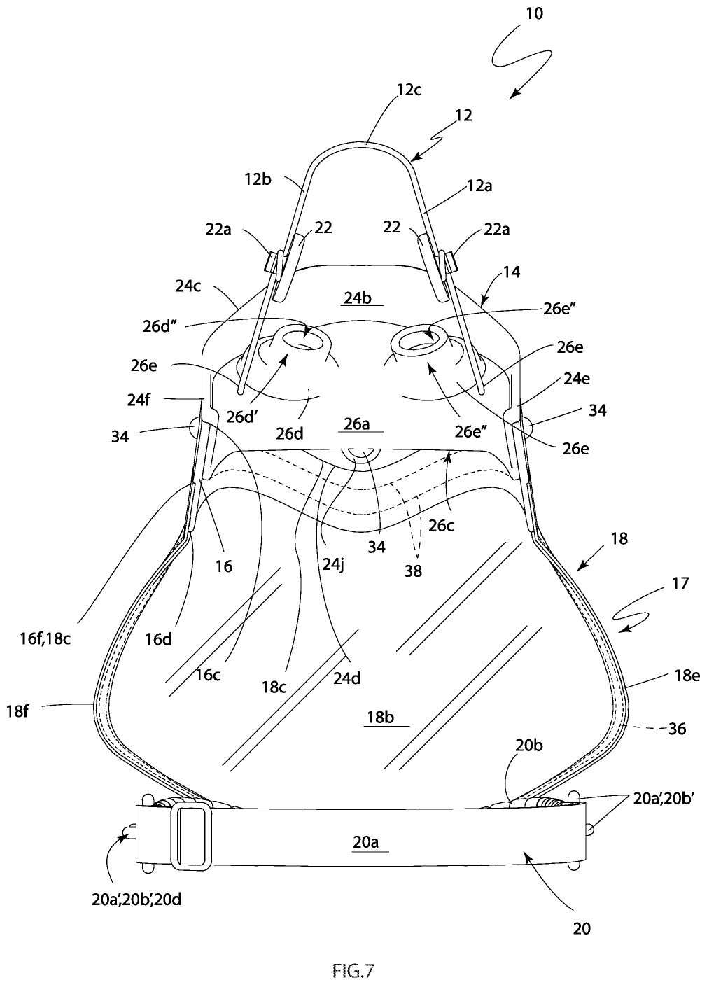

Base 14 includes a first wall 24 that has an exterior surface 24a, an interior surface 24b, an upper edge 24c, a lower edge 24d (FIG. 5), a first side edge 24e (FIG. 7), and a second side edge 24f. The interior surface 24b of first wall 24 is located in close proximity to the person's face when the face mask 10 is worn, while the exterior surface 24a of first wall 24 is remote from the person's face. As discussed above, first wall 24 is generally U-shaped when viewed from above and a distance between the interior surface of the first wall proximate first side edge 24e and the interior surface of the first wall proximate second side edge 24f substantially approximates the width of a lower region of the person's nose “N”.

A lower region 24g (FIGS. 3 and 5) of first wall 24 is offset relative to an upper region of first wall 24. The lower region 24g extends from a shoulder 24h to lower edge 24d. Lower region 24g extends from first side edge 24e through to second side edge 24f. A plurality of laterally spaced-apart apertures 24j are defined in lower region 24g. Each aperture 24j extends from exterior surface 24a through to interior surface 24b. Apertures 24j are defined in lower region 24g a short distance inwardly from each of the left and right side edges 24e, 24f. One or more additional apertures 24j are located between the apertures near the side edges 24e, 24f.

Base 14 further includes a second wall 26 (FIG. 3) that extends rearwardly away from the interior surface 24b of first wall 24 and terminates adjacent first side edge 24e and second side edge 24f. Second wall 26 is spaced a distance downwardly from upper edge 24c of first wall 24 and a distance upwardly from shoulder 24h of first wall 24. Second wall 26 may be integrally molded with first wall 24. In other embodiments, the first and second walls 24, 26 may be molded separately and then joined together in any suitable way, such as by heat welding, for example. Second wall 26 has an upper surface 26a and a lower surface 26b. Second wall 26 terminates in a rear edge 26c (FIG. 7) that is aligned with the first and second side edges 24e, 24f of first wall 24. Second wall 26 angles slightly downwardly from interior surface 24b of first wall 24. The rear end 26c of second wall 26 is slightly convex in shape and is configured to rest upon the person's upper lip “L”, as is illustrated in FIG. 3.

In accordance with an aspect of the present disclosure, a pair of bosses 26d, 26e are molded into second wall 26 and project upwardly from upper surface 24a thereof. This can be seen in FIGS. 3A, 6, and 7. Each boss 26d, 26e comprises a generally hemispherical region that extends upwardly beyond the rest of the upper surface 26a of second wall 26. A remaining portion of second wall 26 extending outwardly from the bosses 26d, 26e forms a skirt that will be positioned below a bottom of the person's nose “N” when the face mask 10 is worn. The two hemispherical bosses 26d, 26e are laterally spaced a distance apart from each other and are configured to flex in any necessary direction in order to be received at least partially within the person's nostrils when the face mask is worn. The flexible material used to fabricate base 14 helps to ensure that face mask 10 can be worn by anyone as the first wall 24 will flex to accommodate different size noses and the second wall 26, particularly bosses 26d, 26e, will flex to allow bosses 26d, 26e to be received into any differently configured and positioned nostrils. The hemispherical bosses 26d, 26e, because of the material from which base 14 is fabricated, can independently flex slightly to the left, right, front, back or anywhere in-between in order to be able to be lined up with the left and right nostrils of the person.

A generally cylindrical wall 26d′ and 26e′ extends upwardly from each hemispherical region 26d, 26e. An aperture 26d″, 26e″ is defined through a center of each cylindrical wall 26d′, 26e′ and the apertures extend between the upper and lower surfaces 26a, 26b of the second wall 26. When face mask 10 is worn, the apertures 26d″, 26e″ place the region of the mask below the lower surface 26b of second wall 26 in fluid communication with the person's nostrils. The skirt of second wall 26 that radiates outwardly from bosses 26d, 26e, prevent air from flowing from above the upper surface 26a of second wall 26 down to below second wall 26. Similarly, the skirt of second wall 26 prevents air from flowing from below the lower surface 26b of second wall 26 to above second wall 26. At least part of the skirt of second wall 26 rests on the person's upper lip “L” (FIG. 3) and rear surface 26c thereof will directly contact the person's skin. So, with first wall 24 of base 14 contacting the sides of the person's nose “N”, the bosses 26d, 26e being received in the person's nostrils, and the skirt of second wall 26 resting on the person's upper lip “L”, with rear edge 26c of second wall 26 in contact with the person's skin, base 14 effectively seals the top of the face mask 10 to the person's face. As a consequence, substantially all airflow into and out of the face mask 10 occurs in a region of the face mask 10 below the lower surface 26b of second wall 26.

As best seen in FIGS. 6 and 7, two small holes 26f are defined in the second wall 26 laterally outside of bosses 26d, 26e. In particular, each of the holes 26f is located between one of the bosses 26d, 26e and that portion of first wall 24 which is integral with or joined to an exterior perimeter of second wall 26. Each hole 26f extends between upper and lower surfaces 26a, 26b of second wall 26. The connector members 12a′ and 12b′ of support assembly 12 are each received through one of the holes 26e in second wall 26. Crimping members 28 are engaged with each connector member 12a′, 12b′ are insertion through holes 26e, thereby securing support assembly 12 to base 14. Support assembly 12 therefore extends upwardly from base 14.

Referring to FIGS. 5 and 6, mounting assembly 16 is configured to be complementary to a portion of base 14 and is selectively engaged therewith as will be described hereafter. Mounting assembly 16 is fabricated from a flexible material. In particular, mounting assembly 16 may be molded from the flexible material. One suitable material for fabrication of mounting assembly 16 is a flexible plastic. Other suitable materials include silicone or TPR. Mounting assembly 16 includes is generally U-shaped when viewed from above and at least an upper region thereof is configured to be complementary to at least the lower region 24g of base 14. Mounting assembly 16 includes a front surface 16a, a rear surface 16b, an upper edge 16c, a lower edge 16d, a first side edge 16e, and a second side edge 16f. A shoulder 16g is defined a distance downwardly from upper edge 16c and extends from first side edge 16e to second side edge 16f. In one embodiment, shoulder 16g is provided approximately midway between upper edge 16c and lower edge 16d. An upper region of mounting assembly 16 is designated by the reference character 30 in FIG. 5, and a lower region of mounting assembly 16 is designated by the reference character 32. Upper region 30 defines a plurality of holes 30a therein. Each hole 30a extends from the front surface 16a of mounting assembly 16 to the rear surface 16b thereof. The number and placement of holes 30a in mounting assembly 16 is complementary to the number and placement to apertures 24j defined in base 24. When face mask 10 is assembled, upper region 30 of mounting assembly 16 overlays lower region 24g of base 24 so that holes 30a and apertures 24j are aligned with one another. Fasteners 34 are then used to secure mounting assembly 16 to base 14. Fasteners 34 are illustrated as being press-fit fasteners but it will be understood that in other embodiments other fasteners could be used instead. For example, the fasteners 34 may be rivets or screws. In one embodiment, fasteners 34 may be selectively removed to permit disengagement of mounting assembly 16 with base 14. In other embodiments, the fasteners may permanent secure mounting assembly 16 to base 14.

Referring to FIGS. 2, 3A, and 5, filter assembly 17 is shown in greater detail. Filter assembly 17 includes a filter 18 that is mounted on a frame 36. Filter 18 is a fabric filter that has a front surface 18a and a rear surface 18b and includes a plurality of pores (not shown) that extend between front and rear surfaces 18a, 18b. The pores in the filter's fabric material are sufficiently large enough to allow air to pass therethrough but are sufficiently small enough to substantially reduce or prevent moisture droplets from passing therethrough. The moisture droplets in question are droplets which may be expelled in the air the person breathes out and/or which are entrained in the person's breath when the person talks, coughs, or sneezes. The fabric filter's pores may substantially reduce or prevent moisture droplets from moving through the pores in a direction from the rear surface 18b to the front surface 18a thereby protecting others in the person's environment. The fabric filter's pores may also substantially reduce or prevent moisture droplets expelled by others or picked up on the person's hands and inadvertently transferred to the filter 18, from moving in a direction from the front surface 18a of the filter 18 to the rear surface 18b thereof.

Frame 36 provided in filter assembly 17 is a stretchable, elastic frame 36 that supports the fabric filter 18 thereon. Frame 36 is molded or otherwise configured so that when filter 18 is engaged therewith, the filter assembly 17 assumes a cupped-shape and is configured to receive the person's chin “C” therein when the mask is worn. As indicated above, filter 18 has a front surface 18a and a rear surface 18b. Filter 18 also has an upper edge 18c, a lower edge 18d, a first side edge 18e, and a second side edge 18f. When face mask 10 is assembled an upper region of filter assembly 17, which includes upper edge 18c of filter 18, overlays the lower region 32 of mounting assembly 16. In particular, the upper edge 18c of filter 18 will butt up against shoulder 16g of mounting assembly 16. Additionally, first side edge 18e of filter 18 will be vertically aligned with first side edge 16e of mounting assembly 16, and second side edge 18f of filter 18 will be vertically aligned with second side edge 16f of mounting assembly 16.

Filter assembly 17 is secured to mounting assembly 16 in any suitable manner. As illustrated in the attached figures, for example, filter assembly 17 may be stitched onto lower region 32 of mounting assembly 16 using one or more rows of stitches 38. In other embodiments, the upper region of filter assembly 17 may be glued to mounting assembly 16 or may be heat welded thereto. In yet other embodiments fasteners may be used. Any suitable way of securing filter assembly 17 to mounting assembly 16 may be used.

In one embodiment, the filter assembly 17 may be detachably engaged with mounting assembly 16. In that embodiment, filter assembly 17 may be selectively removed from its engagement with mounting assembly 16 in order to wash the fabric filter 18. In other instances, filter assembly 17 may be removed from its engagement with mounting assembly 16 and be replaced with a different replacement filter assembly 17. Replacement filter assemblies 17 may be provided where the fabric filter comes in a plurality of different colors and/or patterns and a user may select which particular color or pattern filter 18 they wish to engage in face mask 10.

In another embodiment, the filter assembly 17 may be fixedly or permanently secured to mounting assembly 16. In these instances, when needed, the mounting assembly 16 with engaged filter assembly 17 is disengaged from the base 14 by disconnecting fasteners 34. A replacement mounting assembly with engaged replacement filter assembly is then engaged with base 14 by aligning holes in the mounting assembly with the apertures 24g in base 14 and reinstalling the fasteners 34. In other instances, the engaged mounting assembly 16 and filter assembly 17 may be removed and washed and then reinstalled on the base 14.

Frame 36 of filter assembly 17 is fabricated from a suitable material that allows for filter assembly 17 to be removably sealed to the skin on the user's face. The cupped-shape created in filter assembly 17 by the specially configured frame 36 is such that a portion of the frame 36 and filter 18 will readily seat under the user's chin “C” when the face mask 10 is worn. Frame 36 enables a perimeter of the filter assembly 17 to be removably sealed to the skin on the user's face on either side of their mouth and under their chin. The flexible frame 36 and fabric filter 18 used in filter assembly 17 (along with the resilient base 14 and mounting assembly 160 allows the person to talk and breathe relatively normally without face mask 10 becoming disengaged from the user's face.

In some instances, a person will wear the face mask 10 that comprises only the support assembly 12, the base 14, the mounting assembly 16, and the filter assembly 17. In other instances, where more secure engagement of the mask 10 with the head “H” is sought, the neck strap 20 may be selectively engaged with the filter assembly 17. As best seen in FIG. 5, Neck strap 20 includes a back strap 20a, a chain 20b, a connector assembly 20c, and a clasp assembly 20d. Back strap 20a includes rings 20a′ at either end and is selectively adjustable in length. Chain 20b is of a fixed length and includes rings 20b′ at either end. Connector assembly 20c is a spring member comprised of a flexible material, such as metal, that is bent back upon itself. Connector assembly 20c has a first arm 20e and a second arm 20f that have free ends that are selectively separable from each other to engage the filter assembly 17. The bent spring member forms a passageway 20g through which chain 20b is received. A first of the rings 20b′ of chain 20b is fixedly secured to one of the rings 20a′ of the back strap 20a. The clasp assembly 20d is fixedly secured to the other of the rings 20b′ of chain 20b. The clasp assembly 20d include a hook member 20d′ that is selectively engaged with the other ring 20a′ provided on back strap 20a.

Face mask 10 may be used to help prevent the spread of infection caused by infectious respiratory moisture droplets. Face mask 10 is able to be worn by a person while in an environment where they are in close proximity to other individuals. In particular, face mask 10 is able to be worn to try and reduce the number of respiratory moisture droplets from the person into the environment by capturing at least some of those moisture droplets in the filter 18 provided in the face mask 10. The method of use of face mask 10 includes engaging a base 14 of the face mask 10 around a lower region of the person's nose “N”; positioning a generally horizontal wall 26 of the base 14 under a bottom end of the person's nose “N”; moving a first boss 26d on the wall 26 into a first nostril of the nose “N”; moving a second boss 26e on the wall 26 into a second nostril of the nose “N”; cupping the person's chin “C” with a filter assembly 17 extending downwardly from the base 14; sealing the filter assembly 17 to the person's skin alongside the sides of the persons' mouth and under their chin “C”; and exhaling and inhaling through a filter 18 provided on the filter assembly 17. It will be understood from FIG. 1 that the sides 18e, 18f of the filter 18 are located on either side of the persons' mouth. It will further be understood that the filter assembly 17 does not extend to any great extent laterally along the person's cheeks as the entire face mask 10 is located inside a corridor that is between the imaginary vertical lines “F” and “G”, i.e., a short distance laterally outwardly from the outer ends of the mouth.

The method further comprises sealing the base 14 to the person's upper lip “L” (FIG. 3) with a skirt of the wall 26 26 that radiates outwardly from the first boss 26d and the second boss 26e. The method further comprises preventing airflow to and from the nose or mouth along the sides of the person's nose with the generally horizontal wall 26 of the base 14. As shown in FIG. 3, second wall 26 substantially prevents downward airflow in the direction indicated by arrow “J” from the environment outside the mask along the sides of the nose ‘N’ and into the space 40 defined between an inner surface of the filter 18 and the person's face. As further shown in FIG. 3, the second wall 26 also substantially prevents upward airflow in the direction indicated by arrow “K” along the sides of the nose “N” from the space 40 and into the environment outside the face mask 10. Because of this sealing arrangement between the base 14 and the user's face, and because of the sealing arrangement between the frame 36 of the filter assembly 17 and the user's face, the airflow to and from the person's nose “N” and mouth, i.e., into and out of the space 40 (indicated by arrow “L” in FIG. 3), has to go through the filter 18 of filter assembly 17. Because of this, any entrained respiratory moisture droplets from the person are captured by filter 18. Similarly, any moisture droplets picked up on the person's hands and transferred inadvertently to face mask 10 will be captured by filter 18. If any of the droplets contain infectious agents such as bacteria or viruses, filter 18 will aid in preventing those infectious agents from being transferred between the person and others in the environment.

The method of using face mask 10 further comprises interposing a mounting assembly 16 between the base 14 and the filter assembly 17. The method may further include detachably engaging the mounting assembly 16 to the base 14; removing the mounting assembly 16 and filter assembly 17 from the base 14 periodically; cleaning or replacing the filter assembly 17, (particularly cleaning or replacing filter 18), on the mounting assembly 16; and re-engaging the mounting assembly 16 with the cleaned or replaced filter assembly 17 with the base 14. (It will be understood that in other embodiments, the entire face mask 10 may be cleaned by washing. In yet other embodiments, the entire face mask 10 may be disposed of after use.)

In one embodiment, the method further comprises providing a support assembly 12 extending upwardly from the base 14; resting a pair of nose pads 22 of the support assembly 12 on opposing sides of the person's nose “N”; and when needed, bending a frame 12a, 12b, 12c of the support assembly 12 to conform to the shape of a bridge of the person's nose “N”. In one embodiment, the method further comprises engaging a connector assembly 20c of a neck strap 20 with the filter assembly 17 such that a first portion 20a of the neck strap extends outwardly from the connector assembly 20c in a first direction and a second portion 20b of the neck strap 20 extends outwardly from the connector assembly 20c in a second direction; passing the first portion 20a of the neck strap 20 around the back of the person's neck; and securing a free end 20b′ of the second portion 20b of the neck strap 20 and a free end 20a′ of the first portion 20a of the neck strap 20 together. A clasp 20d may be used for this purpose.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1 % of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A face mask comprising:
a base;
a filter assembly operatively engaged with the base;
wherein the base is adapted to be received about a region of the person's nose when the face mask is worn and seal the face mask to the person's nose.

2. The face mask according to claim 1, wherein the filter assembly extends downwardly from the base and is adapted to receive the person's chin therein and seal the face mask to the person's face adjacent their mouth.

3. The face mask according to claim 1; further comprising:
a filter provided in the filter assembly; said filter being configured to permit air to flow therethrough and being further configured to substantially reduce or prevent moisture droplets from flowing therethrough.

4. The face mask according to claim 1, wherein the base is fabricated from a resilient or flexible material and is generally U-shaped when viewed from above.

5. The face mask according to claim 1, wherein the base is configured to approximate a width of a lower region of the person's nose when the face mask is worn.

6. The face mask according to claim 1, wherein the base includes:
a first wall oriented generally vertically when the face mask is worn; and
a second wall oriented generally horizontally relative to an interior surface of the first wall; and wherein the second wall is adapted to extend under the person's nose and to seal the face mask to the person's nose.

7. The face mask according to claim 6, wherein the second wall includes:
a first boss and a second boss that extend upwardly from an upper surface of the second wall, wherein the first boss and second boss are laterally spaced a distance apart from one another; and
an aperture is defined in each of the first boss and the second boss, and wherein the first boss and second boss are adapted to be at least partially received into the person's nostrils when the face mask is worn.

8. The face mask according to claim 7, wherein each of the first boss and the second boss is generally hemispherical in shape and is fabricated from a flexible material.

9. The face mask according to claim 7, wherein a remaining portion of the second wall extending outwardly from the first boss and the second boss forms a skirt that is adapted to contact the person's upper lip; wherein the skirt substantially reduces or prevents expelled air from flowing upwardly from the person's nose and mouth and out of the face mask adjacent the person's nose; and further substantially reduces or prevents air from an environment surrounding the person from flowing inwardly adjacent the person's nose and into a space defined between the face mask and the person's face.

10. The face mask according to claim 1, wherein the filter assembly further comprises a frame, wherein a filter is mounted to the frame.

11. The face mask according to claim 10, wherein the frame configures the filter to assume a cupped-shape that is adapted to receive the person's chin therein when the face mask is worn.

12. The face mask according to claim 10, wherein the frame is fabricated from an elastic material and is adapted to secure the filter assembly to the person's skin when the face mask is worn.

13. The face mask according to claim 1, further comprising a support assembly operatively engaged with the base, wherein the support assembly extends upwardly from the base and is adapted to engage the person's nose when the face mask is worn.

14. The face mask according to claim 13, wherein the support assembly comprises:
a bendable frame; and
a pair of nose pads mounted on the bendable frame, said nose pads being adapted to rest on a first side and a second side of the person's nose when the face mask is worn.

15. The face mask according to claim 1, further comprising a mounting assembly interposed between the base and the filter assembly, wherein the mounting assembly is detachably engaged with the base.

16. The face mask according to claim 15, wherein the mounting assembly is permanently secured to the filter assembly.

17. The face mask according to claim 1, further comprising a neck strap that is detachably engagable with the filter assembly, wherein the neck strap is adapted to pass around a back of the person's neck when the face mask is worn.

18. A method of preventing a spread of infection caused by infectious respiratory moisture droplets, said method comprising:
providing a face mask for a person to wear on their face while in an environment;
engaging a base of the face mask around a lower region of the person's nose;
sealing the face mask to the person's nose with the base; and
extending a filter assembly downwardly from the base.

19. The method according to claim 18, further comprising:
positioning a generally horizontal wall of the base under a bottom end of the person's nose;
moving a first boss on the wall into a first nostril of the nose; and
moving a second boss on the wall into a second nostril of the nose.

20. The method according to claim 18, further comprising;
cupping the person's chin with a filter assembly extending downwardly from the base;
sealing the filter assembly to the person's skin alongside the sides of the persons' mouth and under their chin;
exhaling and inhaling through a filter provided on the filter assembly; and
capturing infectious respiratory moisture droplets in the filter of the filter assembly.

21. The method according to claim 18, further comprising:
sealing the base to the person's upper lip with a skirt of the wall that radiates outwardly from the first boss and the second boss.

22. The method according to claim 19, further comprising preventing airflow to and from the nose or mouth along the sides of the person's nose with the generally horizontal wall of the base.

23. The method according to claim 18, further comprising:
interposing a mounting assembly between the base and the filter assembly;
detachably engaging the mounting assembly to the base;
removing the mounting assembly and filter assembly from the base periodically;
cleaning or replacing the filter assembly; and
re-engaging the mounting assembly with the cleaned or replaced filter assembly with the base.

24. The method according to claim 18, further comprising:
providing a support assembly extending upwardly from the base;
resting a pair of nose pads of the support assembly on opposing sides of the person's nose; and
when needed, bending a frame of the support assembly to conform to a shape of a bridge of the person's nose.

25. The method according to claim 18, further comprising:
engaging a connector assembly of a neck strap with the filter assembly such that a first portion of the neck strap extends outwardly from the connector assembly in a first direction and a second portion of the neck strap extends outwardly from the connector assembly in a second direction;
passing the first portion of the neck strap around the back of the person's neck; and
securing a free end of the second portion of the neck strap and a free end of the first portion of the neck strap together.
